(19) United States
(12) Patent Application Publication
(10) Pub. No.: US 2004/0201892 A1
(43) Pub. Date: Oct. 14, 2004

(54) Diffraction grating element, optical module and optical communications system

(75) Inventors: Manabu Shiozaki, Yokohama-shi (JP); Masakazu Shigehara, Yokohama-shi (JP)

Correspondence Address: MCDERMOTT WILL & EMERY LLP, 600 13TH STREET, N.W., WASHINGTON, DC, 20005-3096, US

(73) Assignee: Sumitomo Electric Industries, Ltd.

(21) Appl. No.: 10/815,789

(22) Filed: Apr. 2, 2004

Related U.S. Application Data
(60) Provisional application No. 60/459,616, filed on Apr. 3, 2003.

(30) Foreign Application Priority Data
Apr. 3, 2003 (JP) P2003-100566

(51) Int. Cl. G02B 5/18; G02B 27/42; G02B 27/44

(52) U.S. Cl. 359/558

(57) ABSTRACT

The present invention relates a diffraction grating element capable achieving a large angular dispersion and excellent diffraction characteristics. The diffraction grating element has a buried structure, and comprises: a first medium with a refractive index of n₁; a second medium with lower refractive index of n₂ than the first medium; and a diffraction grating formed at the interface between the first and second mediums. One of the first and second mediums is a solid, and the other thereof is a solid or a liquid. An anti-reflection film is formed on one surface of the first medium 11 on which the diffraction grating is not formed, and this anti-reflection film lies in contact with a medium with a refractive index no. Furthermore, an anti-reflection film is also formed on one surface of the second medium on which the diffraction grating is not formed, and this anti-reflection film lies in contact with the medium with the refractive index no. The relationship of the magnitudes of the refractive indices of these respective mediums is “n₁>n₂>nₒ”. The parameters of the diffraction grating lie within predetermined ranges.

### CROSS-REFERENCE TO RELATED APPLICATION

This application claims priority to Provisional Application filed on Apr. 3, 2003, which is hereby incorporated by reference in its entirety.

### BACKGROUND OF THE INVENTION

1. Field of the Invention

The present invention relates to a diffraction grating element for diffracting incident light at an angle according to its wavelength, an optical module including the diffraction grating element, and an optical communications system including the optical module.

2. Related Background Art

A diffraction grating element comprises a transparent flat plate, and a diffraction grating formed on one surface of the flat plate or formed within the flat plate. In this diffraction grating element, the light introduced into the diffraction grating is diffracted by the diffraction grating. The diffraction angle of the light in this case varies depending on the wavelength of the light. Therefore, this diffraction grating element can be used as an optical demultiplexer demultiplexing the incident light every wavelength. Furthermore, when the light is guided in the opposite direction to that described above, then this diffraction grating element can be used as an optical multiplexer multiplexing the incident light of multiple wavelengths. Moreover, by combining this diffraction grating element with another optical element, it is also possible, for example, to constitute a dispersion adjuster for adjusting the group delay time of the light in accordance with its wavelength. Consequently, diffraction grating elements are important optical devices in WDM (Wavelength Division Multiplexing) optical communications systems, which transmit signal light of multiple wavelengths by multiplexing signals.

As a common diffraction grating element, a surface relief-type diffraction grating element, comprising a transparent flat plate and a diffraction grating formed on one surface of the flat plate, is known. The surface relief-type diffraction grating element can be obtain a high diffraction efficiency with respect to both of TE polarized light and TM polarized light by optimizing the shape of this diffraction grating. The diffraction grating element disclosed in the U.S. patent application No. 2002-0135876 (Document 1) is directed to a bonded structure type diffraction grating element comprises a further transparent flat plate bonded to the diffraction grating surface of the above-mentioned surface relief-type diffraction grating element, capable of obtaining a high diffraction efficiency with respect to both of TE polarized light and TM polarized light. Furthermore, the diffraction grating element disclosed in the Japanese Patent Laid-open No. 58-198006 (Document 2) is directed to a buried structure type diffraction grating element comprising a diffraction grating formed at the interface between a first medium and a second medium, and having the object to improve diffraction efficiency by adopting thus a structure.

### SUMMARY OF THE INVENTION

The inventors have studied conventional diffraction grating element in detail, and as a result, have found problems as follows. Namely, in the conventional surface relief-type diffraction grating element, when it is sought to obtain a large angular dispersion, the diffraction efficiency decreases. Also, in this case, the polarization dependence and wavelength dependence increase, and hence the diffraction characteristics are degraded. In the bonded structure type diffraction grating element disclosed in Document 1, a concrete design example is described for achieving a high diffraction efficiency with respect to both of TE polarized light and TM polarized light at the central wavelength, but the element is not suitable for use in WDM optical communications having a predetermined bandwidth because the diffraction characteristics over the whole wavelength band are not taken into consideration. Moreover, Document 1 discloses a buried structure as one aspect of a bonded structure, but no concrete design example is described for achieving a high diffraction efficiency with respect to both of TE polarized light and TM polarized light. On the other hand, in the buried structure type diffraction grating element disclosed in Document 2, although the object is to increase diffraction efficiency, the diffraction efficiency actually achieved is a low figure of 45%, and no concrete design example is described for achieving a higher diffraction efficiency than this.

The present invention was devised in order to resolve the aforementioned problems, an object thereof being to provide a diffraction grating element whereby a large angular dispersion and excellent diffraction characteristics can be obtained, an optical module including the diffraction grating element, and an optical communications system including the optical module.

A diffraction grating element according to the present invention comprises a first medium, a second medium, a diffraction grating. The first medium has a refractive index of n₁. The a second medium has a refractive index of n₂ lower than that of the first medium. The diffraction grating is provided at the interface between the first medium and the second medium. Additionally, one of the first medium and the second medium is a solid, and the other thereof is a solid or a liquid. In particular, in the diffraction grating element according to the present invention, taking the period of the diffraction grating to be Λ, the height of the diffraction grating to be H, the duty ratio of the width of the first medium with respect to the period Λ in the diffraction grating to be f, and the normalized height expressed by (n₁/n₂−1)H/Λ to be Hₙₒᵣₘ, in a two-dimensional plane based on coordinate values (Hₙₒᵣₘ, f), the normalized height Hₙₒᵣₘ and the duty ratio f lie within a region enclosed by linking in sequence, by means of line segments, the point (0.50, 0.32), the point (0.50, 0.75), the point (2.00, 0.90), the point (4.00, 0.90), the point (2.20, 0.76), the point (0.75, 0.32), and the point (0.50, 0.32), or within a region enclosed by linking in sequence, by means of line segments, the point (2.25, 0.20), the point (2.25, 0.44), the point (2.75, 0.44), the point (2.75, 0.20), and the point (2.25, 0.20). Such a diffraction grating element is able to have a large angular dispersion and provide excellent diffraction characteristics in the C-band (1530 nm to 1565 nm)

In the diffraction grating element according to the present invention, in the two-dimensional plane based on coordinate values (Hₙₒᵣₘ, f), the normalized height Hₙₒᵣₘ and the duty ratio f preferably lie within a region enclosed by linking in sequence, by means of line segments, the point (0.60, 0.50), the point (0.60, 0.75), the point (2.00, 0.88), the point (2.40, 0.88), the point (1.50, 0.70), the point (1.10, 0.50), and the point (0.60, 0.50). In this case, the diffraction grating element is able to have a large angular dispersion and provide excellent diffraction characteristics in the L-band (1565 nm to 1625 nm) as well as the C-band.

Furthermore, in the diffraction grating element according to the present invention, in a two-dimensional plane based on coordinate values (Hₙₒᵣₘ, f), the normalized height Hₙₒᵣₘ and the duty ratio preferably f lie within a region enclosed by linking in sequence, by means of line segments, the point (0.80, 0.62), the point (0.80, 0.65), the point (1.00, 0.75), the point (1.60, 0.82), the point (1.75, 0.82), the point (0.96, 0.60), and the point (0.80, 0.62). In this case, the diffraction grating element has even more excellent diffraction characteristics.

Additionally, it is preferable that, in the diffraction grating element according to the present invention, the period Λ of the diffraction grating is 1.46 μm or less. In this case, incident angle will be 35° or more, and the beneficial effects of the buried structure are enhanced.

In the diffraction grating element according to the present invention, it is preferable that the refractive index ratio (n₁/n₂) is 1.25 or more but 1.6 or less. In this case, diffraction characteristics are particularly excellent.

The optical module according to the present invention includes a diffraction grating element having the structure described above (the diffraction grating element according to the present invention), and multiplexes or demultiplexes light by using this diffraction grating element. Since the optical module includes a diffraction grating element having a large angular dispersion and excellent diffraction characteristics, it is compact in size and has low loss, low polarization dependence and low wavelength dependence.

Furthermore, in the optical module according to the present invention, the incident angle or the diffraction angle of the light in the second medium of the diffraction grating element is preferably 60° or less, more preferably, the incident angle or the diffraction angle of the light in the second medium of the diffraction grating element is 25° or more but 35° or less. In this case, the diffraction characteristics of the diffraction grating element are particularly excellent, and therefore the loss, polarization dependence and wavelength dependence of the optical module will be even lower.

The optical communications system according to the present invention includes an optical module having the structure described above (the optical module according to the present invention). The optical communications system according to the present invention transmits signal light, and multiplexes or demultiplexes the signal light by using this optical module. Since the optical communications system includes an optical module having low loss, low polarization dependence and low wavelength dependence, it enables high-quality optical communications.

Additionally, it is preferable that, in the optical communications system according to the present invention, a Bragg condition of the diffraction grating in the diffraction grating element included in the optical module is satisfied at any wavelength within the signal wavelength band. In this case, optical communications of even higher quality become possible.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is a view showing a configuration of a surface relief type diffraction grating element;

FIG. 2 is a graph showing the relationship between the angular dispersion and the incident angle θ in the surface relief type diffraction grating element of FIG. 1;

FIG. 3 is a graph showing the relationship between the diffraction characteristics and the incident angle θ in the surface relief type diffraction grating element of FIG. 1;

FIG. 4 is a view showing a configuration of one embodiment of a diffraction grating element according to the present invention;

FIG. 5 is a diagram showing the range of normalized height Hₙₒᵣₘ and duty ratio f in which excellent diffraction characteristics are obtained in the diffraction grating element of FIG. 4;

FIG. 6 is a graph showing the relationship between the diffraction characteristics and the refractive index ratio (n₁/n₂) in a diffraction grating element of FIG. 4;

FIG. 7 is a diagram showing the range of normalized height Hₙₒᵣₘ and duty ratio f in which excellent diffraction characteristics are obtained in the diffraction grating element of FIG. 4;

FIG. 8 is a view showing a configuration of a first embodiment of an optical module according to the present invention;

FIG. 9 is a view showing a configuration of a second embodiment of an optical module according to the present invention;

FIG. 10 is a view showing a configuration of a third embodiment of an optical module according to the present invention; and

FIG. 11 is a view showing a configuration of one embodiment of an optical communications system according to the present invention.

### DETAILED DESCRIPTION OF THE PREFERRED EMBODIMENTS

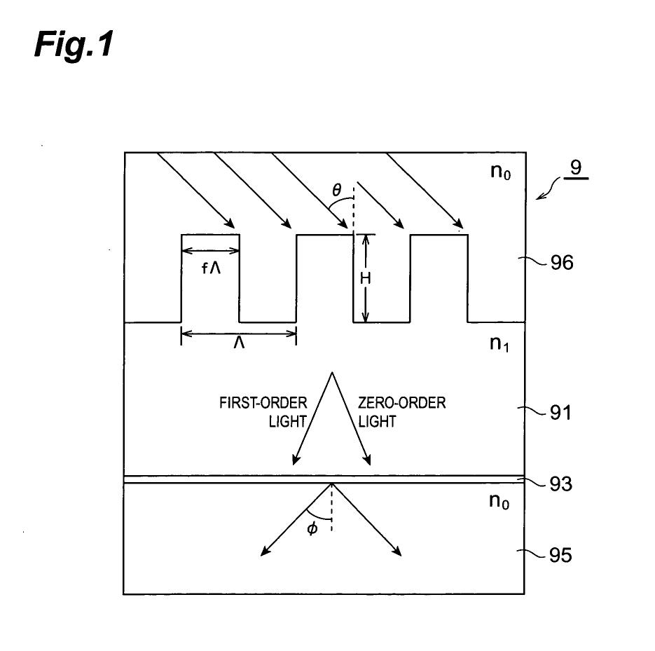

In the following, embodiments of a diffraction grating element, an optical module and an optical communications system according to the present invention will be explained in detail with reference to FIGS. 1 to 11. In the explanation of the drawings, constituents identical to each other will be referred to with numerals identical to each other without repeating their overlapping descriptions.

FIG. 1 is a view showing a configuration of a surface relief type diffraction grating element Here, FIG. 1 shows a diffraction grating element 9 as viewed in the direction in which the respective gratings extend in the diffraction element. The diffraction grating element 9 shown in FIG. 1 comprises a medium 91 with a refractive index of n₁ as a transparent flat plate, and a diffraction grating is formed on one surface of the medium 91. The surface on which the diffraction grating is formed is in contact with a medium 96 with a refractive index of nₒ, and an anti-reflection film 93 is formed on the other face of the medium 91. This anti-reflection film 93 is in contact with a medium 95 with a refractive index of no.

In the diffraction grating element 9, the grating period of the diffraction grating is taken to be Λ, the height of the diffraction grating is taken to be H, and the duty ratio of the width of the medium 91 with respect to the period Λ in the diffraction grating is taken to be f. The grating width is taken to be fΛ. Furthermore, the incident angle of the light incident on the diffraction grating from the medium 96 is taken to be θ, and the diffraction angle of the first-order diffraction light emitted from the medium 91, through the anti-reflection film 93 and into the medium 95 is taken to be φ.

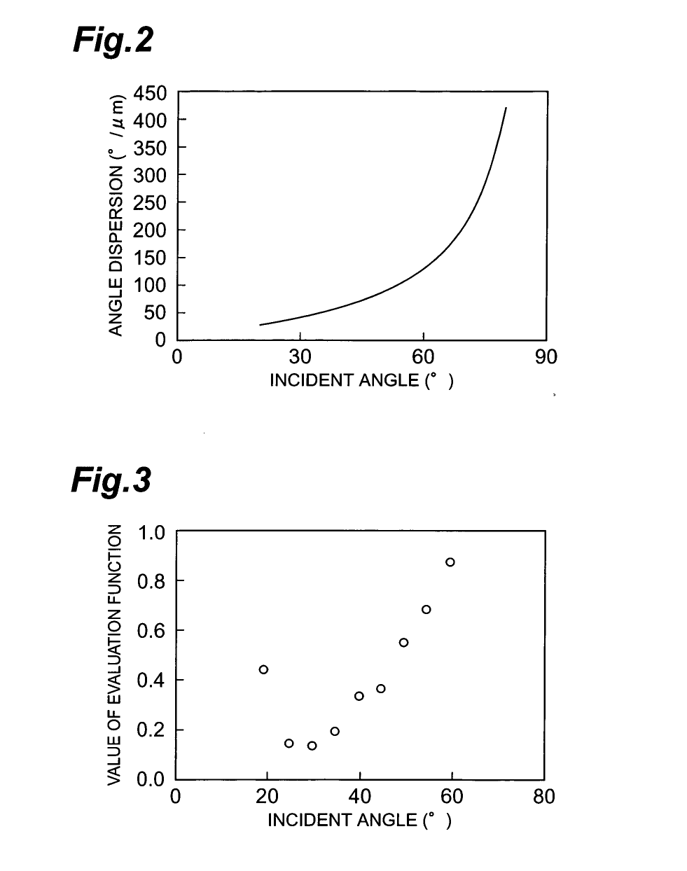

FIG. 2 is a graph showing the relationship between the angular dispersion and the incident angle θ in the surface relief type diffraction grating element 9. Here, the angular dispersion of FIG. 2 indicates one of the transmitted first-order diffracted light. The wavelength λ of the incident light in a vacuum is taken to be 1.55 μm. The period Λ of the diffraction grating is set in such a manner that the incident angle of the incident light satisfies “Bragg condition” (in other words, condition where the respective emission angles of the transmitted zero-order light and the transmitted first-order diffracted light are mutually equal), at the wavelength of 1.55 μm.

The Bragg condition is expressed by the following formula (1). Moreover, the angular dispersion D is expressed by the following formula (2).

$$\begin{matrix}Λ = \vert \frac{λ}{{}_{}^{2}{n}{}_{0}^{} sin θ} \vert & ( 1 ) \\ D = \vert \frac{ⅆ φ}{ⅆ λ} \vert = \vert \frac{{}_{}^{2}{n}{}_{0}^{} tan θ}{λ} \vert & ( 2 )\end{matrix}$$

Here, the reason that the Bragg condition is applied is that a high diffraction efficiency is generally obtained in a diffraction grating, when the Bragg condition is satisfied, and furthermore, since the respective emission angles of the transmitted zero-order light and the transmitted first-order diffraction light are respectively equal, then the anti-reflection film 93 can be manufactured readily.

As can be seen from FIG. 2, the larger the incident angle θ, the greater the angular dispersion, and hence desired wavelength resolution can be obtained, even at a very short distance from the diffraction grating element 9. Therefore, the larger the incident angle θ, the greater the possibility of achieving a more compact size for an optical module containing this diffraction grating element (for example, an optical multiplexer, optical demultiplexer, optical filter, dispersion adjuster, or the like).

FIG. 3 is a graph showing the relationship between the diffraction characteristics and the incident angle θ of a surface relief type diffraction grating element 9. Here, the diffraction characteristics are evaluated by the value of the evaluation function expressed by the following formula (3).

$$“ EVALUATION FUNCTION ” = max ( \frac{1 - {η}_{min}}{1 - 0.8} , \frac{{η}_{max} - {η}_{min}}{0.05} ) \qquad ( 3 )$$

The parameters ηₘₐₓ, ηₘᵢₙ in this evaluation function are the maximum value and the minimum value of the diffraction efficiency of the transmitted first-order diffraction light for all wavelengths in the C-band (wavelength 1530 nm to 1565 nm) and all types of polarization. The smaller the value of the evaluation function, the better the diffraction characteristics. When the value of the evaluation function is 1 or less, then the values of 80% or more for the diffraction efficiency and 5% or less for the polarization dependence, which are required in normal WDM optical communications, will be satisfied.

Moreover, in FIG. 3, the period Λ of the diffraction grating is established in such a manner that the Bragg condition is satisfied in the central wavelength λ₀ of the C-band. The respective refractive indices nₒ of the medium 95 and the medium 96 are taken to be 1. The incident angle θ is set in 5° periods between 20° and 80°, the refractive index n₁ of the medium 91 is set in periods of 0.05 between 1.05 to 3.0, the height H/λ₀ normalized to the central wavelength was set in periods of 0.05 between 0 and 5.0, and the duty ratio f is set in periods of 0.02 between 0 and 1. The value of the evaluation function is determined by carrying out a simulation using Rigorous Coupled-Wave Analysis (RCWA), based on all of the combinations of the various values for these parameters, and the minimum value of the evaluation function for each value of the incident angle θ is determined.

As can be seen from FIG. 3, the incident angle θ must be set to 60° or less in order to be suitable for use in WDM optical communications, and in particular, when the incident angle θ is 35° or above, there is remarkable deterioration of the diffraction characteristics. In other words, in the signal wavelength band of 1.26 μm-1.675 μm, from the formula (1), when the period Λ of the diffraction grating is 1.46 μm or less, there is marked degradation of the diffraction characteristics.

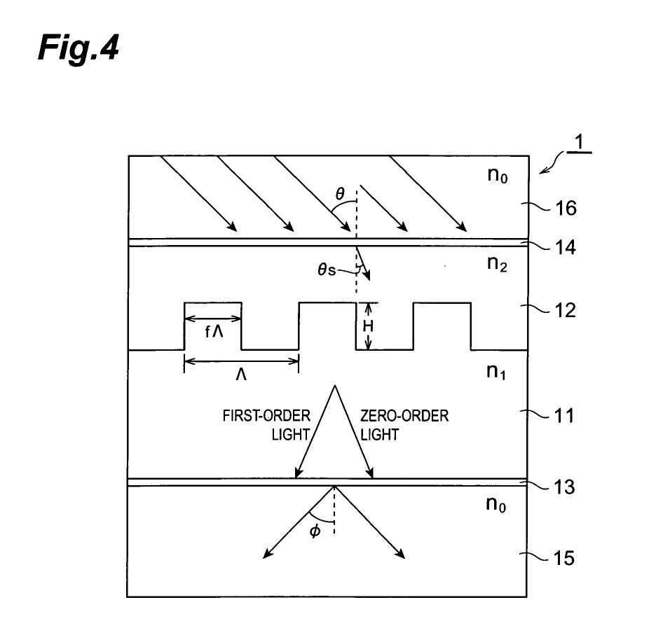

FIG. 4 is a view showing a configuration of one embodiment of a diffraction grating element according to the present invention. Here, FIG. 4 shows a diffraction grating element 1 as viewed in the direction in which the respective gratings extend in the diffraction grating element. The diffraction grating element 1 shown in FIG. 4 has a buried structure, and comprises a first medium 11 with a refractive index of n₁, a second medium 12 with a refractive index of n₂, and a diffraction grating formed at the interface between the first medium 11 and the second medium 12. Of the first medium 11 and the second medium 12, one is a solid and the other is either a solid or a liquid. An anti-reflection film 13 is formed on the surface of the first medium 11 on which the diffraction grating is not formed, and this anti-reflection film 13 lies in contact with a medium 15 with a refractive index of no. Furthermore, an anti-reflection film 14 is formed on the surface of the second medium 12 on which the diffraction grating is not formed, and this anti-reflection film 14 lies in contact with a medium 16 with a refractive index of nₒ. The relationship of the magnitude of the refractive indices of the respective media is “n₁>n₂>n₀”.

In the diffraction grating element 1, the grating period of the diffraction grating is taken to be Λ, the height of the diffraction grating, supposing the diffraction grating to have a square cross-section, is taken to be H, and the duty ratio of the width of the first medium 11 with respect to the period Λ in the diffraction grating is taken to be f. The grating width of the diffraction grating is taken to be fΛ. Furthermore, the incident angle of the light incident on the anti-reflection film 14 from the medium 16 is taken to be θ, the incident angle of the light incident at the diffraction grating from the second medium 12 is taken to be θₛ, and the diffraction angle of the transmitted first-order diffracted light passing through the anti-reflection film 13 from the first medium 11 and emitted into the medium 15 is taken to be φ.

Between the buried structure type diffraction grating element 1 shown in FIG. 4 and the surface relief type diffraction grating element 9 shown in FIG. 1, when the period Λ of the diffraction grating, the wavelength λ of the incident light, the refractive index no of the respective media 15, 16, 95, 96, and the incident angle θ of the light from the media 16, 96 are respectively equal, then the diffraction angle of the transmitted first-order diffracted light emitted into the media 15, 95 and the angular dispersion thereof, will also be equal. Since the refractive index n₂ of the second medium 12 is greater than the refractive index no of the medium 16, the incident angle θₛ of the light from the second medium 12 to the diffraction grating will be less than the incident angle θ of the light from the medium 16. For this reason, the incident angle θₛ of the light from the second medium 12 to the diffraction grating can be reduced to 60° or less, and in particular, by setting this incident angle θₛ to be between 25° and 35°, it is possible to obtain excellent diffraction characteristics and angular dispersion in the diffraction grating element 1, as can be seen from FIG. 3. Here, FIG. 3 shows the results of calculations in a case where n₀=1 and n₁=1.05 to 3, but by substituting the term n₁ in FIG. 1 with the term n₁/n₂ in FIG. 4, and substituting the term θ in FIG. 1 with the term θₛ in FIG. 4, it also coincides with the configuration of the diffraction grating element 1 shown in FIG. 4.

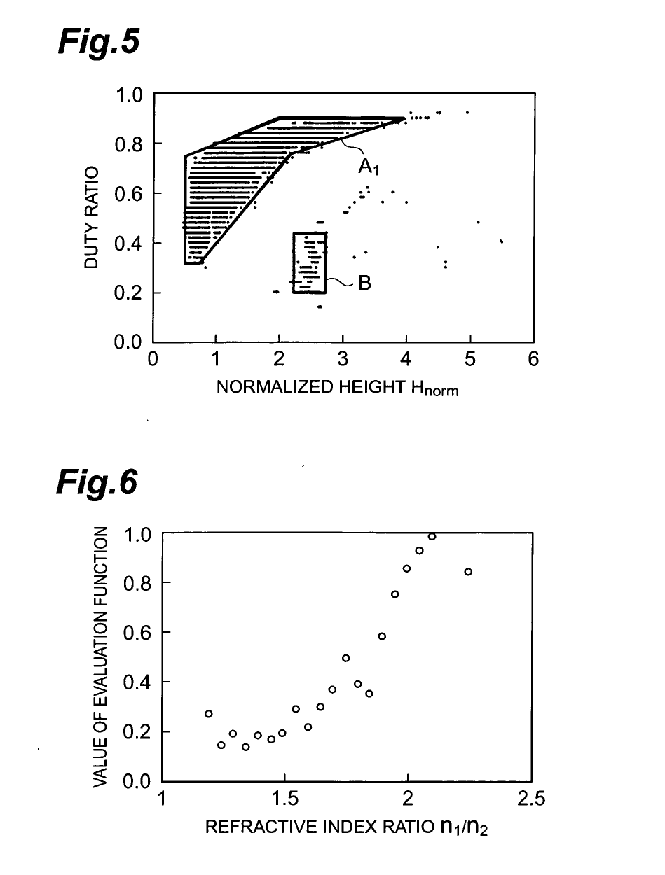

FIG. 5 is a diagram showing the ranges of the normalized height Hₙₒᵣₘ and the duty ratio f in which excellent diffraction characteristics are obtained in the diffraction grating element 1 of FIG. 4. Here, the normalized height Hₙₒᵣₘ is defined by the following formula (4).

$${H}_{norm} = ( \frac{{n}_{1}}{{n}_{2}} - 1 ) \frac{H}{Λ} \qquad ( 4 )$$

In this formula (4), the term H/Λ is multiplied by (n₁/n₂−1) because the greater the difference between the refractive indices n₁ and n₂, the higher the diffraction efficiency that can be obtained even when the diffraction grating has a low height H.

The period Λ of the diffraction grating is set in such a manner that the Bragg condition is satisfied at the central wavelength λ0 of the C-band, and the incident angle θₛ of the light from the second medium 12 to the diffraction grating is set in 5° periods between 20° and 80°, the refractive index ratio (n₁/n₂) is set in periods of 0.05 between 1.05 and 3.0, the height normalized by the central wavelength n₂H/λ₀ is set in periods of 0.05 between 0 and 5.0, and the duty ratio f is set in periods of 0.02 between 0 and 1. A simulation is carried using an RCWA method, based on all of the combinations of the various values for these parameters, and respective values for ηₘᵢₙ and Δη(=ηₘₐₓ−ηₘᵢₙ) are calculated. The terms ηₘₐₓ and ηₘᵢₙ are the maximum value and minimum value of the diffraction efficiency of the transmitted first-order diffracted light, for all wavelengths in the C-band and all types of polarization. Thereupon, the conditions where ηₘᵢₙ was 0.8 or above and Δη was 0.05 or less, has been determined.

The points in FIG. 5 indicate the position of the conditions (Hₙₒᵣₘ, f) at which excellent diffraction characteristics (ηₘᵢₙ>0.8, Δη<0.05) are obtained. That is, the regions A1 and B in FIG. 5 respectively show the ranges of the conditions in which the above-mentioned diffraction characteristics are obtained. In a two-dimensional plane based on coordinate values (Hₙₒᵣₘ, f), the region A1 is a region enclosed when the point (0.50, 0.32), the point (0.50, 0.75), the point (2.00, 0.90), the point (4.00, 0.90), the point (2.20, 0.76), the point (0.75, 0.32), and the point (0.50, 0.32) are linked by line segments, in said order. On the other hand, in a two-dimensional plane based on coordinate values (Hₙₒᵣₘ, f), the region B is a region enclosed when the point (2.25, 0.20), the point (2.25, 0.44), the point (2.75, 0.44), the point (2.75, 0.20), and the point (2.25, 0.20) are linked by line segments, in said order. Accordingly, by designing the respective parameters in such a manner that the normalized height Hₙₒᵣₘ and the duty ratio f are contained within the region A1 or within the region B, it is possible to obtain a diffraction grating element 1 having excellent diffraction characteristics in the C-band.

FIG. 6 is a graph showing the relationship between the diffraction characteristics and the refractive index ratio (n₁/n₂) of the diffraction grating element 1 of FIG. 4. Here, the diffraction characteristics is evaluated by the evaluation function expressed by the formula (3). The terms ηₘₐₓ and ηₘᵢₙ are the maximum value and minimum value of the diffraction efficiency of the transmitted first-order diffracted light, for all wavelengths in the C-band and all types of polarization. Also, in FIG. 6, the period Λ of the diffraction grating is set in such a manner that the Bragg condition is satisfied at the central wavelength λ₀ of the C-band. Furthermore, the incident angle θₛ of the light from the second medium 12 to the diffraction grating is set in 5° periods between 20° and 80°, the refractive index ratio (n₁/n₂) is set in periods of 0.05 between 1.05 and 3.0, the height normalized by the central wavelength n₂H/λ₀ is set in periods of 0.05 between 0 and 5.0, and the duty ratio f is set in periods of 0.02 between 0 and 1. Values for the evaluation function have been determined by performing a simulation using an RCWA method, based on all of the combinations of the various values for these parameters, and the minimum value of the evaluation function has been also determined for the respective values of the refractive index ratio (n₁/n₂). As can be seen from FIG. 6, when the refractive index ratio (n₁/n₂) is 1.85 or less, furthermore the range of 1.25 to 1.6, the values of the evaluation function become small.

In practical terms, the diffraction grating element 1 according to the present invention is designed by the following procedure. The period Λ of the diffraction grating and the incident angle θ of the light from the medium 16 are determined from the required values for the used wavelength λ and the angular dispersion, the incident angle θₛ′ of the light from the second medium 12 to the diffraction grating is determined, and furthermore, respective materials for the first medium 11 and the second medium 12 with a predetermined refractive indices are determined from the viewpoints of diffraction characteristics (FIG. 6) and manufacturability. The diffraction grating element 1 designed in this way will have excellent diffraction characteristics, with the normalized height Hₙₒᵣₘ and duty ratio f being contained in the region A1 or the region B. In the description thus far, it is supposed that the wavelength band of the incident light is the C-band, but since the respective parameters of the diffraction grating obey a similarity rule (for example, when the central wavelength is doubled, then both of the period Λ and the height H should also be doubled), then the wavelength band of the incident light can readily be set to another band.

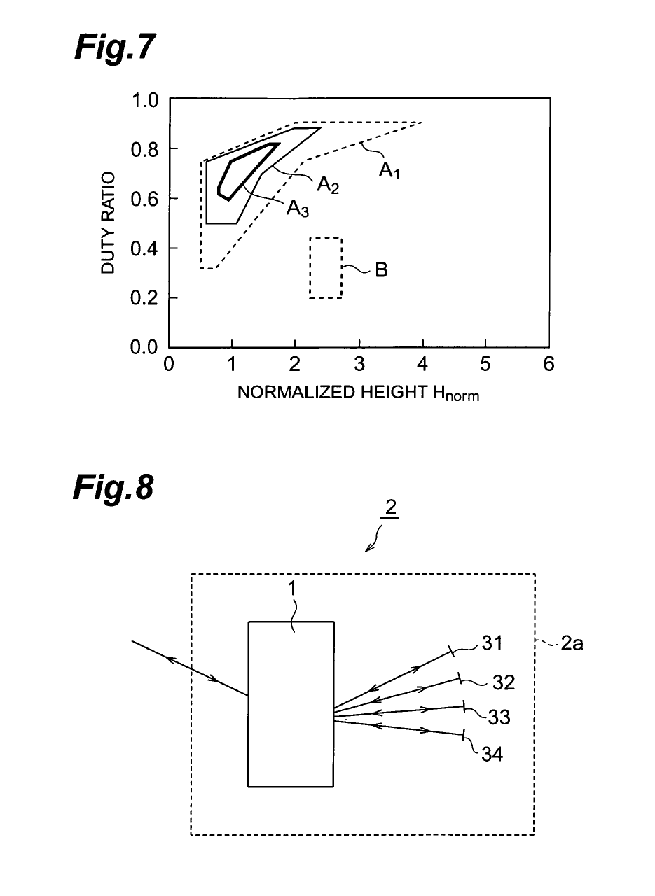

FIG. 7 is a diagram showing the range of the normalized height Hₙₒᵣₘ and the duty ratio f in which even more excellent diffraction characteristics can be obtained in the diffraction grating element 1 of FIG. 4. In a two-dimensional plane based on coordinate values (Hₙₒᵣₘ, f), the region A2 is a region enclosed when the point (0.60, 0.50), the point (0.60, 0.75), the point (2.00, 0.88), the point (2.40, 0.88), the point (1.50, 0.70), the point (1.10, 0.50), and the point (0.60, 0.50) are linked by line segments, in said order. This region A2 indicates the range of condition in which ηₘᵢₙ is 0.9 or more and Δη is 0.025 or less in the C-band, the range of condition in which ηₘᵢₙ is 0.85 or more and Δη is 0.035 or less in the L-band (wavelength of 1565 nm to 1625 nm), and the range of condition in which ηₘᵢₙ is 0.8 or more and Δη is 0.05 or less in both of the C-band and the L-band. By using the diffraction grating element 1 which satisfies these conditions, the element can be used in the L-band and not only in the C-band, and it may also be used in both of the C-band and the L-band. Since high diffraction efficiency can be obtained in the C-band, even when used together with other optical elements having optical loss, it is still possible to reduce the overall loss, and it is also possible to reduce communications errors.

In a two-dimensional plane based on coordinate values (Hₙₒᵣₘ, f), the region A3 in FIG. 7 is a region enclosed when the point (0.80, 0.62), the point (0.80, 0.65), the point (1.00, 0.75), the point (1.60, 0.82), the point (1.75, 0.82), the point (0.96, 0.60), and the point (0.80, 0.62) are linked by line segments, in said order. This region A3 indicates the range of conditions in which ηₘᵢₙ is 0. 97 or more in the C-band, the range of condition in which ηₘᵢₙ is 0.965 or more in the L-band, and the range of conditions in which ηₘᵢₙ is 0. 95 or more over both of the C-band and the L-band. In all of these cases, when ηₘᵢₙ is 0. 95 or more, then Δη will be 0.05 or less. By using the diffraction grating element 1 which satisfies these conditions, even when used together with other optical elements having optical loss, it is still possible sufficiently to reduce the overall loss, and it is also possible markedly to reduce communications errors.

In the foregoing, a case where light is directed from a second medium 12 to the first medium 11 has been described, but the same also applies in a case where the light is directed from the first medium 11 to the second medium 12. Furthermore, in the foregoing description, the design parameter is restricted to the Bragg condition, but the invention is not limited to the condition. When the respective parameters are designed in such a manner that the conditions contained in the regions A1, A2 or A3 or B are satisfied, it is possible to obtain a diffraction grating element which has good diffraction characteristics, even if the conditions diverge from the Bragg condition. In practice, even in the foregoing description, although the Bragg condition is satisfied at the central wavelength, the Bragg condition is not satisfied at wavelengths other than the central wavelength. Even so, excellent diffraction characteristics are obtained in the C-band or L-band.

However, when the element is designed in such a manner that the Bragg condition or the condition near the Bragg condition is satisfied, high diffraction characteristics are obtained, and moreover, since the respective emission angles of the transmitted zero-order light, the transmitted first-order diffraction light and the reflected first-order diffraction light are mutually equal, the anti-reflection films 13, 14 can be formed readily. In this regard, the reflected first-order diffracted light propagates in the opposite direction to the traveling direction of the incident light at the wavelength that the Bragg condition is satisfied. This matter may causes an undesirable case in practical use. Therefore, although the Bragg condition is satisfied at some wavelengths within the used wavelength band, the used wavelength is desirably set in such a manner that it does not satisfies the Bragg condition. For example, taking the used wavelengths to be λ₁, λ₂, λ₃, . . . , λₙ, λₙ₊₁, . . . , λ_{N}, in ascending order, the wavelength satisfying the Bragg condition should be set to (λₙ+λₙ₊₁)/2.

Furthermore, by designing the element in such a manner that the Bragg condition or the condition near the Bragg condition is satisfied, and by ensuring that the incident angle θ, of the light from the second medium 12 to the diffraction grating is 20° or more, the respective refractive indices of the first medium 11 and the second medium 12 are set so as to satisfy the relationship (5).

η₁≦³n₂ sin θ, (5)

At this time, only transmitted zero-order light, transmitted first-order diffracted light and reflected first-order diffracted light are generated in the first medium 11 and the second medium 12, and therefore it is possible to suppress the adverse effects created by reflection of the other diffracted light at the anti-reflection films 13, 14, and in view of this point also, excellent characteristics can be obtained. Additionally, by respectively setting the first medium 11 and the second medium 12 to a suitably thick dimension in comparison with the wavelength (for example, a thickness of 5 μm or more in the case of a communications waveband), then it is possible to suppress adverse effects caused by the reflection of evanescent waves at the anti-reflection films 13, 14, and in view of this point also, excellent characteristics can be obtained.

Next, the method of manufacturing the diffraction grating element 1 shown in FIG. 4 and the specific configuration thereof will be explained. Grooves are formed by etching on the surface of the first medium 11 of a transparent solid material, and the grooves are buried by a second medium 12 of a transparent liquid material. Or, the grooves are buried by vapor deposition of a second medium 12 of a transparent solid material. Alternatively, on the other hand, it is also possible to form grooves on the surface of the second medium 12 of a transparent solid material, and to bury these grooves by means of a first medium 11 of a solid material or a liquid material. In the case that the grooves are buried by vapor deposition, since the surface of the deposited medium is also liable to produce periodic indentations, due to the effects of the shapes of the grooves, then desirably, the surface of the vapor deposited medium is flattened by polishing, or the like.

For example, the second medium 12 is taken to be made from silica glass (refractive index n₂=1.45), and the first medium 11 is taken to be made from TiO₂, Ta₂O₅ or Nb₂O₅ (the refractive index n₁ in any of these materials is n₁=2.0 to 2.2). The ratio of refractive indices (n₁/n₂) is 1.4 to 1.5, which is desirable in view of FIG. 6, since the value of the evaluation function will be small and the diffraction characteristics will be excellent. When the media 15, 16 are taken to be air (refractive index n₀=1), then the incident angle θₛ of the light from the second medium 12 to the diffraction grating will be smaller than the incident angle θ of the light from the medium 16 to the anti-reflection film 14, and hence a higher diffraction efficiency will be obtained in comparison to the case of a surface relief type diffraction grating element. In particular, when the incident angle θ of the light from the medium 16 to the anti-reflection film 14 is 40° to 55°, then the incident angle θₛ of the light from the second medium 12 to the diffraction grating element will be 25° to 35°, and in view of FIG. 3, this is desirable, since the evaluation function value will be small and diffraction characteristics will be excellent.

Furthermore, it is also possible to employ a material of even higher refractive index (for example, a semiconductor) as the first medium 11, grooves being formed in the surface of this first medium 11 by etching and a second medium 12 being formed by vapor deposition. For example, the first medium 11 is made from a semiconductor (for example, silicon having a refractive index n₁=3.5), and the second medium 12 is TiO₂ (refractive index n₂=2.2). In this case, the refractive index ratio (n₁/n₂) is 1.6. When the incident angle θ of the light from the medium 16 to the anti-reflection film 14 is 68° or more, then the incident angle θₛ of the light from the second medium 12 to the diffraction grating will be 25° to 30°. As can be seen from FIG. 3, since the value of the evaluation function will be small, the diffraction characteristics will be excellent, and furthermore, a large angular dispersion will be obtained.

The foregoing description is directed to the case in which light from the second medium 12 with a lower refractive index than the first medium 11 is incident on a diffraction grating, but the present invention allows cases in where light is incident on the diffraction grating from the first medium 11. Furthermore, in the foregoing description, the diffraction grating element 1 is described to be one functioning as an optical demultiplexer, but the diffraction grating element 1 can function as an optical multiplexer in the case that the light propagates in the opposite direction to the foregoing. In this way, the diffraction grating element 1 is able to constitute an optical multiplexer or an optical demultiplexer in an optical module, in combination with light input and output ports for inputting and outputting light.

In the following, embodiments of an optical module according to the present invention will be explained.

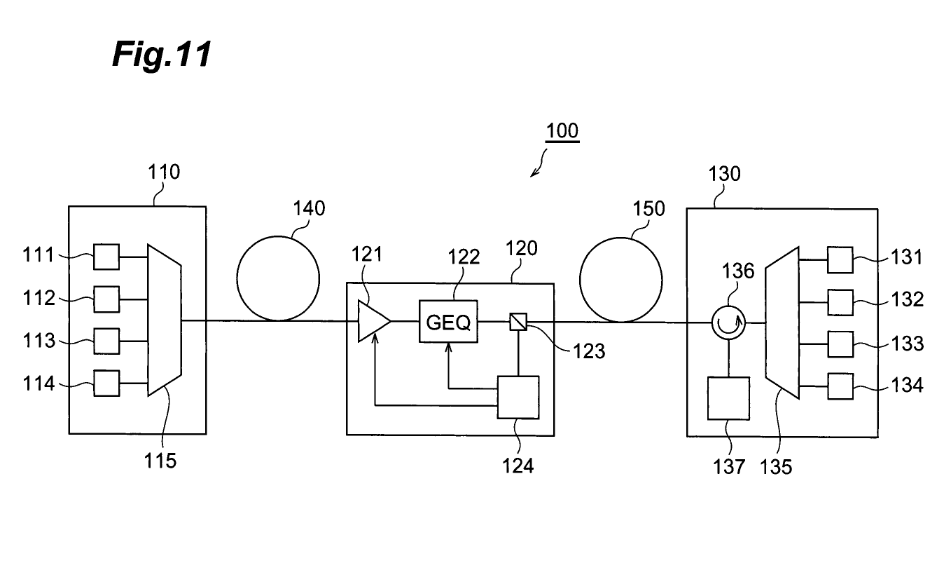

First, FIG. 8 is a view showing a configuration of a first embodiment of an optical module according to the present invention. The optical module 2 according to the first embodiment comprises the diffraction grating element 1 and a plurality of mirror reflectors 31 to 34 which are arranged so as to correspond to the respective wavelengths included in the signal light. Furthermore, the optical module 2 may comprises a housing 2a for hermetically sealing the diffraction grating element 1. As shown in FIG. 8, when the diffraction grating element 1 is used in combination with mirror reflectors 31 to 34 which reflect the light emitted from the first medium 11 to the medium 15, the optical module 2 according to the first embodiment, including this diffraction grating element 1 and the mirror reflectors 31 to 34, demultiplexes the incident by using the diffraction grating element 1, reflects the light of respective demultiplexed wavelengths by using the mirror reflectors 31 to 34, and multiplexes the respective wavelengths of the reflected light by using the diffraction grating element 1. In this case, by establishing a suitable optical path length for each wavelength from demultiplexing until multiplexing (in other words, by setting the mirror reflectors 31 to 34 in suitable positions), the optical module 2 can be used as a dispersion adjuster for adjusting the group delay time of light of respective wavelengths. This optical module 2 can also be used in combination with an optical circulator (see FIG. 11).

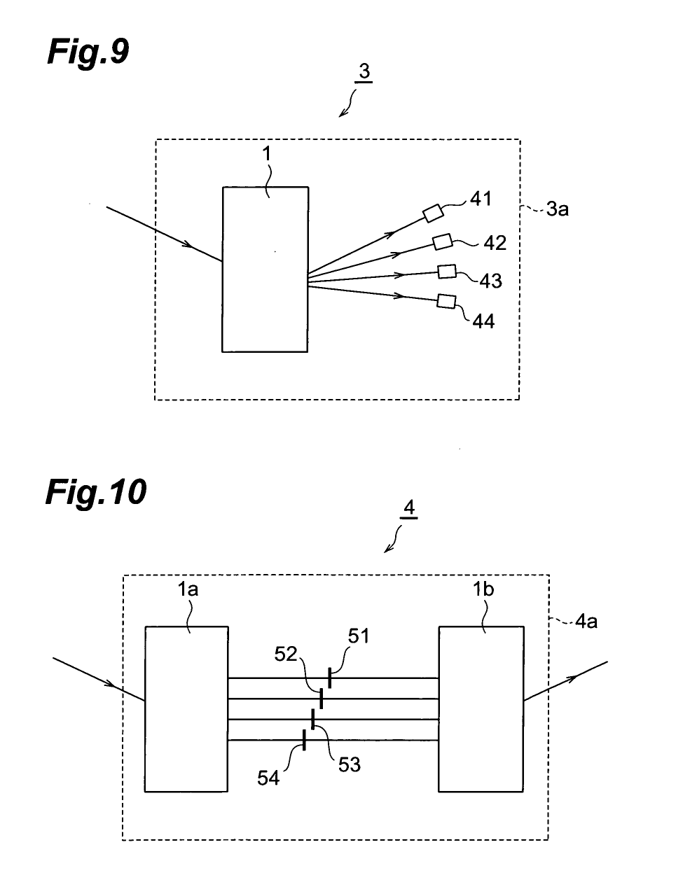

FIG. 9 is a view showing a configuration of a second embodiment of an optical module according to the present invention. The optical module 3 according to the second embodiment comprises the diffraction grating element 1 in similar to the first embodiment, and further comprises a plurality of photoreceptor elements 41 to 44 instead of the mirror reflectors 31 to 34 of the first embodiment. Furthermore, the optical module 3 may comprises a housing 3a for hermetically sealing the diffraction grating element 1. As shown in FIG. 9, when the diffraction grating element 1 is used in combination with photoreceptor elements 41 to 44 which detect the optical power emitted from the first medium 11 to the medium 15, the optical module 3 according to the second embodiment, including this diffraction grating element 1 and the photoreceptor elements 41 to 44, can be used as a spectral detector for detecting the optical power at respective wavelengths.

Furthermore, FIG. 10 is a view showing a configuration of a third embodiment of an optical module according to the present invention. The optical module 4 according to the third embodiment comprises two diffraction grating elements 1a and 1b each having the same structure of the diffraction grating element 1 of the first embodiment, and a plurality of optical attenuators 51 to 54 arranged between the two diffraction grating elements 1a and 1b. Furthermore, the optical module 4 may comprises a housing 4a for hermetically sealing the diffraction grating element 1. As shown in FIG. 10, in the optical module, the incident light is demultiplexed by the diffraction grating element 1a (optical demultiplexer), whereupon a predetermined loss is applied to the light of respective demultiplexed wavelengths in this manner, by means of the optical attenuators 51 to 54, and then the light of respective wavelengths is multiplexed by means of the diffraction grating element 1b (optical multiplexer). This optical module 4 may be used as an optical filter, and it may also be used as a gain equalizer for equalizing the gain of an optical amplifier. In the configuration of the first embodiment shown in FIG. 8, when optical attenuators are inserted between the diffraction grating element 1 and the mirror reflectors 31 to 34, it is also possible to obtain an optical filter.

The optical modules 2 to 4 described above can be used suitably in a WDM optical communications system, as an optical demultiplexer, optical multiplexer, dispersion adjuster, spectral detection device, and optical filter, and the like. Since these optical modules 2 to 4 includes the diffraction grating element 1 according to the present invention or a plurality of diffraction grating elements each having the same structure as the diffraction grating element 1, which has a large angular dispersion and excellent diffraction characteristics as described above, the optical modules will be compact in size, and have low loss, low polarization dependence and low wavelength dependence.

Additionally, in the diffraction grating element 1 included in these optical modules, the incident angle or diffraction angle of the light in the second medium 12 with a lower refractive index than the first medium 11 is preferably 60° or lower, and more preferably, the incident angle or diffraction angle of the light in the second medium 12 is 25° or more but 35° or less. In this case, since particularly excellent diffraction characteristics are obtained in the diffraction grating element 1, the optical module will have even lower loss, polarization dependence and wavelength dependence.

Next, an embodiment of an optical communications system according to the present invention will be explained. FIG. 11 is a view showing a configuration of one embodiment of an optical communications system according to the present invention. The optical communications system 100, shown in FIG. 11, comprises an optical transmitter 110, an optical repeater 120, and an optical receiver 130, an optical fiber transmission line 140 laid between the optical transmitter 110 and the optical repeater 120, and an optical fiber transmission line 150 being laid between the optical repeater 120, and the optical receiver 130.

The optical transmitter 110 comprises light sources 111-114 and an optical multiplexer 115. The light sources 111-114 output signal light of mutually different wavelengths. The optical multiplexer 115 multiplexes the signal light components outputted from the respective light sources 111-114, and outputs the multiplexed signal light to the optical fiber transmission line 140.

The optical repeater 120 comprises an optical amplifier 121, a gain equalizer 122, an optical coupler 123, and a spectral detector 124. The optical amplifier 121 inputs signal light that reaches it after propagating through the optical fiber transmission line 140, and amplifies the signal light. The optical amplifier 121 outputs the amplified signal light. The gain equalizer 122 inputs the signal light outputted from the optical amplifier 121 and applies losses corresponding to wavelength to the signal light, thereby equalizing the gain of the amplifier 121. The optical coupler 123 separates a part of the signal light outputted from the gain equalizer 122 and outputs the part to the spectral detector 124, whilst outputting the rest of the signal light to the optical fiber transmission line 150. The spectral detector 124 monitors the power of the signal light arriving from the optical coupler 123, for each wavelength. The respective operations of the optical amplifier 121 and the gain equalizer 122 are controlled on the basis of the monitoring results provided by the spectral detector 124.

The optical receiver 130 comprises photoreceptors 131-134, an optical demultiplexer 135, an optical circulator 136, and a dispersion adjuster 137. The optical circulator 136 inputs the signal light arriving at it after propagating through the optical fiber transmission line 150, and outputs the signal light to the dispersion adjuster 137. Moreover, the optical circulator 136 inputs the signal light reaching it from the dispersion adjuster 137, and outputs the signal light to the optical demultiplexer 135. The optical demultiplexer 135 inputs the multiplexed signal light outputted from the dispersion adjuster 137, and demultiplexes the signal light into separate wavelengths, the signal light of each respective wavelength being outputted to the photoreceptors 131-134. The photoreceptors 131-134 receive the signal light arriving from the optical demultiplexer 135.

This optical communications system 100 operates in the following manner. In the optical transmitter 110, the signal light outputted from the respective light sources 111-114 is multiplexed by the optical multiplexer 115, and is outputted to the optical fiber transmission line 140. At the optical repeater 120, the multiplexed signal light arriving it after propagating through the optical fiber transmission line 140 is amplified by the optical amplifier 121, and the power at each wavelength is equalized by the gain equalizer 122, whereupon the amplified signal light is outputted to the optical fiber transmission line 150. Furthermore, the power of the signal light at each respective wavelength outputted to the optical fiber transmission line 150 is monitored by the spectral detector 124, and the operation of both of the optical amplifier 121 and the gain equalizer 122 is controlled on this basis of the results of this monitoring, whereby, even when the number of channels in the signal light arriving at the optical repeater 120, or the like, the power of the signal light at each wavelength outputted to the optical fiber transmission line 150 will be equalized. In the optical receiver 130, the multiplexed signal light arriving the receiver after propagating through the optical fiber transmission line 150 is inputted via the optical circulator 136 to the dispersion adjuster 137, and dispersion of the inputted light is compensated by the dispersion adjuster 137. After dispersion-compensating, the light is inputted to the optical demultiplexer 135 by way of the optical circulator 136. The multiplexed signal light inputted to the optical demultiplexer 135 is demultiplexed into respective wavelengths by the optical demultiplexer 135, and the respective wavelength components are received by the photoreceptors 131-134.

In the optical communications system 100, the above-mentioned diffraction grating element 1 is used respectively as an optical multiplexer 115 and an optical demultiplexer 135, the above-mentioned optical module 4 is used as a gain equalizer 122, the optical module 3 described above is used as a spectral detector 124, and the above-mentioned optical module 2 is used as a dispersion adjuster 137. Since the respective optical modules have low loss, low polarization dependence and low wavelength dependence, this optical communications system 1 enables high-quality optical communications. Moreover, desirably, in the optical communications system 100, a Bragg condition in the diffraction grating of the diffraction grating element 1 included in the respective optical modules is satisfied at any wavelength within the signal wavelength band, and in this case, optical communications of even higher quality are possible.

As described in detail above, the diffraction grating element according to the present invention is able to have a large angular dispersion and excellent diffraction characteristics in a predetermined wavelength band.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A diffraction grating element, comprising:
a first medium having a refractive index of n₁;
a second medium arranged so as to be in contact with said first medium, said second medium having a refractive index of n₂ lower than that of said first medium; and
a diffraction grating provided at the interface between said first medium and said second medium,
wherein one of said first medium and said second medium is a solid, and the other thereof is a solid or a liquid, and
wherein, taking the period of said diffraction grating to be Λ, the height of said diffraction grating to be H, the duty ratio of the width of said first medium with respect to the period Λ in said diffraction grating to be f, and the normalized height expressed by (n₁/n₂−1) H/Λ to be Hₙₒᵣₘ, in a two-dimensional plane based on coordinate values (Hₙₒᵣₘ, f), the normalized height Hₙₒᵣₘ and the duty ratio f lie within a region enclosed by linking in sequence, by means of line segments, the point (0.50, 0.32), the point (0.50, 0.75), the point (2.00, 0.90), the point (4.00, 0.90), the point (2.20, 0.76), the point (0.75, 0.32), and the point (0.50, 0.32), or within a region enclosed by linking in sequence, by means of line segments, the point (2.25, 0.20), the point (2.25, 0.44), the point (2.75, 0.44), the point (2.75, 0.20), and the point (2.25, 0.20).

2. A diffraction grating element according to claim 1, wherein, in the two-dimensional plane based on coordinate values (Hₙₒᵣₘ, f), the normalized height Hₙₒᵣₘ and the duty ratio f lie within a region enclosed by linking in sequence, by means of line segments, the point (0.60, 0.50), the point (0.60, 0.75), the point (2.00, 0.88), the point (2.40, 0.88), the point (1.50, 0.70), the point (1.10, 0.50), and the point (0.60, 0.50).

3. A diffraction grating element according to claim 1, wherein, in the two-dimensional plane based on coordinate values (Hₙₒᵣₘ, f), the normalized height Hₙₒᵣₘ and the duty ratio f lie within a region enclosed by linking in sequence, by means of line segments, the point (0.80, 0.62), the point (0.80, 0.65), the point (1.00, 0.75), the point (1.60, 0.82), the point (1.75, 0.82), the point (0.96, 0.60), and the point (0.80, 0.62).

4. A diffraction grating element according to claim 1, wherein the period Λ of said diffraction grating element is 1.46 μm or less.

5. A diffraction grating element according to claim 1, wherein the refractive index ratio (n₁/n₂) between said first medium and said second medium is 1.25 or more but 1.6 or less.

6. An optical module including a diffraction grating element according to claim 1, said optical module multiplexing or demultiplexing light by using said diffraction grating element.

7. An optical module according to claim 6, wherein the incident angle or the diffraction angle of the light in said second medium of said diffraction grating element is 60° or less.

8. An optical module according to claim 6, wherein the incident angle or the diffraction angle of the light in said second medium of said diffraction grating element is 25° or more but 35° or less.

9. An optical communications system including an optical module according to claim 6, said optical communications system transmitting signal light, and multiplexing or demultiplexing the signal light by using said optical module.

10. An optical communications system according to claim 9, wherein, in a signal wavelength band, a Bragg condition of said diffraction grating in said diffraction grating element included in said optical module is satisfied.
